(19) United States
(12) Patent Application Publication
(10) Pub. No.: US 2024/0313207 A1
(43) Pub. Date: Sep. 19, 2024

(54) POSITIVE ELECTRODE ACTIVE MATERIAL FOR SODIUM ION BATTERY, METHOD FOR PREPARING POSITIVE ELECTRODE ACTIVE MATERIAL FOR SODIUM ION BATTERY

(71) Applicants: INDUSTRY-ACADEMIC COOPERATION FOUNDATION OF SUNCHON NATIONAL UNIVERSITY, Suncheon-si (KR); INDUSTRY ACADEMY COOPERATION FOUNDATION OF SEJONG UNIVERSITY, Seoul (KR)

(72) Inventors: Kee Sun SOHN, Seoul (KR); Myoung Ho PYO, Suncheon-si (KR); Woon Bae PARK, Suncheon-si (KR); Amol Bhairuba IKHE, Suncheon-si (KR)

(21) Appl. No.: 18/587,011

(22) Filed: Feb. 26, 2024

(30) Foreign Application Priority Data
Mar. 15, 2023 (KR) 10-2023-0034016

(51) Int. Cl. H01M 4/485; H01M 4/02; H01M 4/36; H01M 4/48; H01M 10/054

(52) U.S. Cl. CPC H01M 4/485; H01M 4/366; H01M 4/483; H01M 10/054; H01M 2004/021; H01M 2004/028

(57) ABSTRACT

A positive electrode active material for a sodium ion battery, which has excellent cycle stability and durability against humidity, and a sodium ion battery containing the same are described. The positive electrode active material for a sodium ion battery includes core particles having a composition of Formula 1 below, and a shell composed of chromium oxide formed on a surface of the core particles.

Na(Cr₁₋₂ₓAl₂ₓ)O₂ (x is 0.001 to 0.1) [Formula 1]

### CROSS-REFERENCE TO RELATED APPLICATIONS

This application claims the priority of Korean Patent Application No. 10-2023-0034016 filed on Mar. 15, 2023, in the Korean Intellectual Property Office, the disclosure of which is incorporated herein by reference in its entirety.

### BACKGROUND OF THE INVENTION

### Field of the Invention

The present invention relates to a positive electrode active material for a sodium ion battery, which has excellent cycle stability and durability against humidity, a sodium ion battery containing the same, and a method for preparing a positive electrode active material for a sodium ion battery.

### Description of the Related Art

Sodium ion batteries have been explored as a potential alternative to lithium ion batteries that dominate the market at present. Typical positive electrode active materials for sodium ion batteries include polyanionic compounds and layered transition metal oxides.

The polyanionic compounds (e.g., phosphate, pyrophosphate, fluorophosphate, NASICON-structure, sulfate, silicate) are generally formed of tetrahedral anionic units interconnected with transition metal polyhedral units, and thus have high operational potential and cycle stability, but have unfavorable aspects such as low electronic conductivity and insufficient rate characteristics in the case of no surface or shape modification.

The layered transition metal oxides have relatively high electronic/ion conductivity, and thus are capable of fast charge/discharge, but have poor cycle stability due to multiple phase transitions caused upon charge/discharge and are also highly sensitive to humidity, making it difficult to manufacture electrodes or store the electrodes for the long term.

O3-NaCrO₂ has a reasonable level of reversible capacity, nearly flat charge/discharge voltage, and high thermal stability, and thus is one of the most promising positive electrode active materials among the layered transition metal oxides, and O3-NaCrO₂ also undergoes multiple phase transitions upon charge/discharge, and in this case, when Na⁺ is extracted up to Na_{0.4-0.5}CrO₂, phase transitions reversibly take place into O3/O′3, O′3, O′3/P′3, and P′3. In addition, further extraction of Na⁺ results in irreversible structural changes from a layered structure to a rock-salt structure along with concomitant chromium ion migration. Even when de-sodiation is limited to Na_{0.5}CrO₂ considering the above-described structural changes, capacity continues to decrease over repeated charge/discharge cycles, and generally, O3-NaCrO₂ shows a capacity retention of less than 80% with respect to an initial capacity within 100 charge/discharge cycles.

### RELATED ART DOCUMENT

### Patent Document

(Patent Document 0001) Korean Patent Laid-Open Publication No. 2022-0131268

### SUMMARY OF THE INVENTION

The invention intends to provide a positive electrode active material for a sodium ion battery, which has excellent cycle characteristics and durability against humidity, and a sodium ion battery including the positive electrode active material.

The invention also intends to provide a method for preparing a positive electrode active material for a sodium ion battery, which may produce a positive electrode active material for a sodium ion battery, which has a core-shell structure and excellent cycle characteristics and durability against humidity through a one-pot process.

According to a first aspect of the invention, there is provided a positive electrode active material for a sodium ion battery, which includes core particles having a composition of Formula 1 below and a shell composed of chromium oxide formed on a surface of the core particles.

Na(Cr₁₋₂ₓAl₂ₓ)O₂ (x is 0.001 to 0.1) [Formula 1]

According to a second aspect of the invention, there is provided a sodium ion battery including a positive electrode, a negative electrode disposed at a predetermined distance from the positive electrode, a separator disposed between the positive electrode and the negative electrode, and an electrolyte charged between the positive electrode and the negative electrode, and the separator, wherein the positive electrode includes a positive electrode active material including core particles having a composition of Formula 1 above and a shell composed of chromium oxide formed on a surface of the core particles.

According to a third aspect of the invention, there is provided a method for preparing a positive electrode active material for a sodium ion battery, which includes dissolving a sodium (Na) precursor, a chromium (Cr) precursor, and an aluminum (Al) precursor in a solvent to prepare a solution, adding a chelating agent to the solution and stirring the mixture, drying the solution to obtain a compound containing sodium, chromium, and aluminum, heating the compound at a temperature of 400 to 600° C. to remove carbon contained in the compound, and sintering the compound from which the carbon is removed at a temperature of 700 to 1,000° C. to obtain a positive electrode active material including core particles having a composition of Formula 1 above and a shell composed of chromium oxide formed on a surface of the core particles.

### BRIEF DESCRIPTION OF THE DRAWINGS

FIG. 1 is a scanning electron microscope image of synthesized NCO and xC-NCAO (x=1, 2.5, 5);

FIG. 2 is an XRD pattern of synthesized NCO and xC-NCAO (x=1, 2.5, 5);

FIG. 3 shows the results of full-pattern Rietveld analysis of 1C-NCAO;

FIG. 4 shows changes in lattice dimension and mol % of Cr₂O₃ according to x in xC-NCAO;

FIG. 5A is an XPS spectrum of Na, Cr, and Al for NCO and xC-NCAO, FIG. 5B is EDX mapping results related to an STEM image of 1C-NCAO, FIG. 5C is a high-resolution TEM image of 1C-NCAO, and FIG. 5D is an electron diffraction pattern of a portion indicated by a square in FIG. 5C;

FIGS. 6A to 6G show changes in charge/discharge profiles of each sample over 100 cycles, FIG. 6H shows changes in capacity when the charge/discharge rate of 1C-NCAO is altered, and FIG. 6I shows changes in capacity when the charge/discharge rate of NCO is altered; and

FIG. 7A is an XRD pattern of NCO and 1C-NCAO according to exposure time to air, FIG. 7B is a thermogravimetric curve, FIG. 7C is the FTIR spectrum of NCO and 1C-NCAO after exposure to air for 24 hours, and FIG. 7D is an image showing a difference between NCO and 1C-NCAO when immersed in water.

### DETAILED DESCRIPTION OF THE EXEMPLARY EMBODIMENTS

Embodiments of the invention will be described in detail with reference to the accompanying drawings to the extent that those skilled in the art may readily practice. However, the invention may be embodied in many different forms and should not be construed as limited to the embodiments set forth herein.

In addition, in the drawings, anything unnecessary for describing the invention will be omitted for clarity, and also like reference numerals refer to like elements throughout.

Throughout the specification, the term “connected to” is used to designate a connection of one element to another element and include both a case where an element is “directly connected to” another element and a case where an element is “electronically connected to” another element via still another element.

Throughout the description, the term “on” that is used to designate a position of one element with respect to another element includes both a case that the one element is adjacent to the another element and a case that any other element is present between these two elements. Throughout the description, when an element “includes” a component, it may indicate that the element does not exclude another component unless explicitly described to the contrary, but can further include another component.

The terms “about”, substantially”, and the like used throughout the description indicates that when a natural manufacturing and a substance allowable error are suggested, such an allowable error corresponds the value or is similar to the value, and such values are intended for the sake of clear understanding of the invention or to prevent an unconscious infringer from illegally using the disclosure of the invention.

Throughout the description, the description of “A and/or B” indicates “A or B, or A and B”.

A positive electrode active material for a sodium ion battery according to the invention includes core particles having a composition of Formula 1 below, and a shell composed of chromium oxide formed on a surface of the core particles.

Na(Cr₁₋₂ₓAl₂ₓ)O₂ (x is 0.001 to 0.1) [Formula 1]

In the positive electrode active material according to the invention, when x is less than 0.001, a thickness of the formed Cr₂O₃ shell is not sufficient, and accordingly, cycle characteristics and resistance against water may be reduced, and when x is greater than 0.1, capacity is reduced. Therefore, the range of 0.001 to 0.1 is preferable. x may more preferably be 0.001 to 0.09, 0.001 to 0.08, 0.001 to 0.07, 0.0015 to 0.06, 0.002 to 0.05, 0.0025 to 0.004, 0.003 to 0.035, 0.0035 to 0.003, 0.004 to 0.0025, 0.0045 to 0.002, 0.005 to 0.018, 0.006 to 0.017, 0.007 to 0.016, 0.008 to 0.015.

In the positive electrode active material according to the invention, the chromium oxide may be Cr₂O₃.

In the positive electrode active material according to the invention, the core particles may be coated with the chromium oxide at a molar ratio of xCr₂O₃ (x is 0.001 to 0.03). x above may be 0.001 to 0.09, 0.001 to 0.08, 0.001 to 0.07, 0.0015 to 0.06, 0.002 to 0.05, 0.0025 to 0.004, 0.003 to 0.035, 0.0035 to 0.003, 0.004 to 0.0025, 0.0045 to 0.002, 0.005 to 0.018, 0.006 to 0.017, 0.007 to 0.016, 0.008 to 0.015.

In the positive electrode active material according to the invention, the shell may have a thickness of 1 to 30 nm. When the thickness of the shell is less than 1 nm, cycle characteristics and resistance against water may be reduced, and when the thickness of the shell is greater than 30 nm, capacity may be reduced. Therefore, the range of 1 to 30 nm is preferable. The thickness of the shell may be more preferably 1.5 to 25 nm, 2 to 20 nm, 2.5 to 10 nm, 3 to 8 nm, or 4 to 6 nm.

In the positive electrode active material according to the invention, the positive electrode active material may be inert to water (H₂O) or moisture in the air.

A sodium ion battery according to the invention includes a positive electrode, a negative electrode disposed at a predetermined distance from the positive electrode, a separator disposed between the positive electrode and the negative electrode, and an electrolyte charged between the positive electrode and the negative electrode, and the separator, and the positive electrode includes a positive electrode active material including core particles having a composition of Formula 1 above and a shell composed of chromium oxide formed on a surface of the core particles.

The positive electrode may be formed to include a current collector and a positive electrode active material layer formed on the current collector. The current collector may include a metal current collector, for example, aluminum foil. The positive electrode active material layer may be prepared as a composition in the form of a mixture of a positive electrode active material powder, a conductive material, a binder, and a solvent, which is then molded and laminated on the metal current collector or applied onto the metal current collector to manufacture a positive electrode.

The negative electrode may be formed to include a current collector and a negative electrode active material layer formed on the current collector. The negative electrode active material layer may be prepared by applying a mixture prepared by mixing a negative electrode active material powder, a conductive material, a binder, and a solvent, directly onto a metal current collector and drying the resulting product, or casting a negative electrode active material composition onto a separate substrate, separating the composition from the substrate, and laminating the composition on a metal current collector. The negative electrode active material is not particularly limited as long as it is used in a sodium ion battery and is capable of reversible intercalation and de-intercalation of sodium ions.

The separator may preferably have a satisfactory electrolyte wettability while having low resistance against the movement of ions included in an electrolyte. The separator may be in the form of a nonwoven fabric or a woven fabric selected from, for example, glass fiber, polyester, Teflon, polyethylene, polypropylene, polytetrafluoroethylene (PTFB), or a combination thereof, and include polyethylene, polypropylene, and the like which are widely used in lithium-ion batteries.

The electrolyte is a non-aqueous electrolyte and may preferably be formed of an organic material, and a sodium salt may be dissolved in the organic material.

According to a method for preparing a positive electrode active material for a sodium ion battery includes dissolving a sodium (Na) precursor, a chromium (Cr) precursor, and an aluminum (Al) precursor in a solvent to prepare a solution, adding a chelating agent to the solution and stirring the mixture, drying the synthesized compound to obtain a compound containing sodium, chromium, and aluminum, heating the compound at a temperature of 400 to 600° C. to remove carbon contained in the compound, and sintering the compound from which the carbon is removed at a temperature of 700 to 1,000° C. to obtain a positive electrode active material including core particles having a composition of Formula 1 above and a shell composed of chromium oxide formed on a surface of the core particles.

In the method for preparing a positive electrode active material of the invention, the chelating agent may preferably be citric acid, but is not necessarily limited thereto.

In the method for preparing a positive electrode active material of the invention, the solvent may preferably be water, but is not necessarily limited thereto.

### EXAMPLE

All chemicals (purity >99.5%) used in Examples of the invention were purchased from Merck. NaCrO₂ and xCr₂O₃-coated Na(Cr₁₋₂ₓAl₂ₓ)O₂ (x=0.01, 0.025, and 0.5) were prepared through a sol-gel method using citric acid as a chelating agent.

NaNO₃, Cr(NO₃)₃·9H₂O, and Al(NO₃)₃·9H₂O were dissolved in 50 ml of water at a molar ratio of 1:1:x to synthesize these materials. Then, citric acid was added to the solution, stirred at 70° C. for several hours, and then dried in a vacuum oven at 150° C. A black-green precursor thus produced was decarbonized in air at 500° C. for 6 hours, and then sintered at 900° C. in an Ar/H₂ (5%) atmosphere to synthesize NaCrO₂ and xCr₂O₃-coated Na(Cr₁₋₂ₓAl₂ₓ)O₂ powder.

In addition, for comparison, aluminum-doped Na(Cr_{0.95}Al_{0.05})O₂ and 0.025Cr₂O₃ chromium oxide-coated NaCrO₂ were also synthesized through the same process as above. To prevent phase changes and surface reactions due to moisture contained in the atmosphere, all synthesized materials were stored in an argon-filled glove box.

### Component and Structural Analysis of Synthesized Compounds

In Examples of the invention, simply, an Al precursor was added in a stoichiometric ratio to a solution containing Cr and Na precursors. In this case, an amount of Al was changed to 2, 5, and 10 mol % of Cr to synthesize 0.01Cr₂O₃-coated NaCr_{0.98}Al_{0.02}O₂ (hereinafter referred to as ‘1C-NCAO’), 0.025Cr₂O₃-coated NaCr_{0.95}Al_{0.050}O₂ (hereinafter referred to as ‘2.5C-NCAO’), and 0.05Cr₂O₃-coated NaCr_{0.90}Al_{0.10}O₂ (hereinafter referred to as ‘5C-NCAO’). Meanwhile, NaCO₂ is indicated as ‘NCO’.

Whether an Al-doped NaCrO₂ core and a Cr₂O₃ shell was spontaneously formed was investigated through the one-pot synthesis.

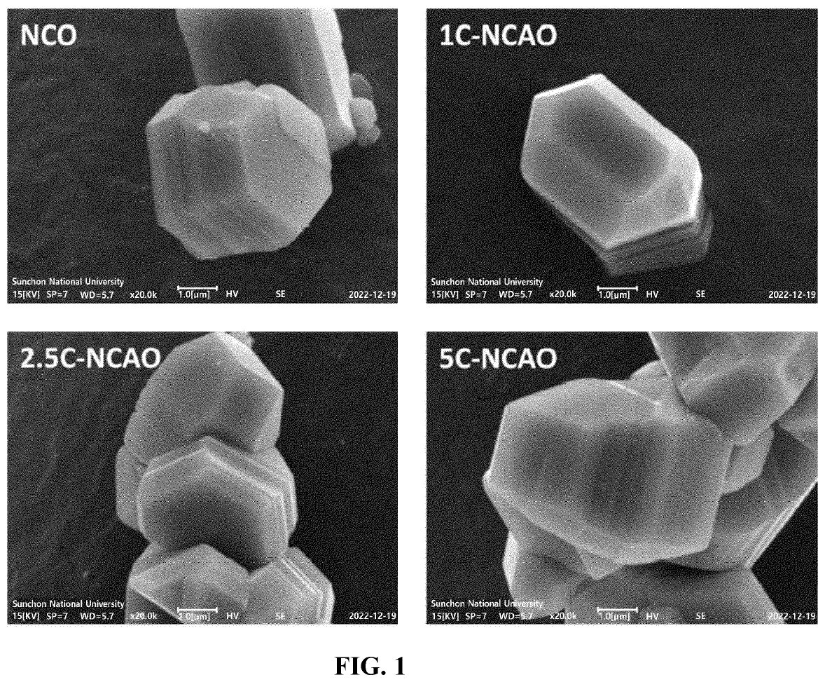

FIG. 1 is a scanning electron microscope image of synthesized NCO and xC-NCAO (x=1, 2.5, 5). As shown in FIG. 1, all compounds synthesized through the above-described sol-gel method have a plate-like shape that reflects the characteristics of layered compounds.

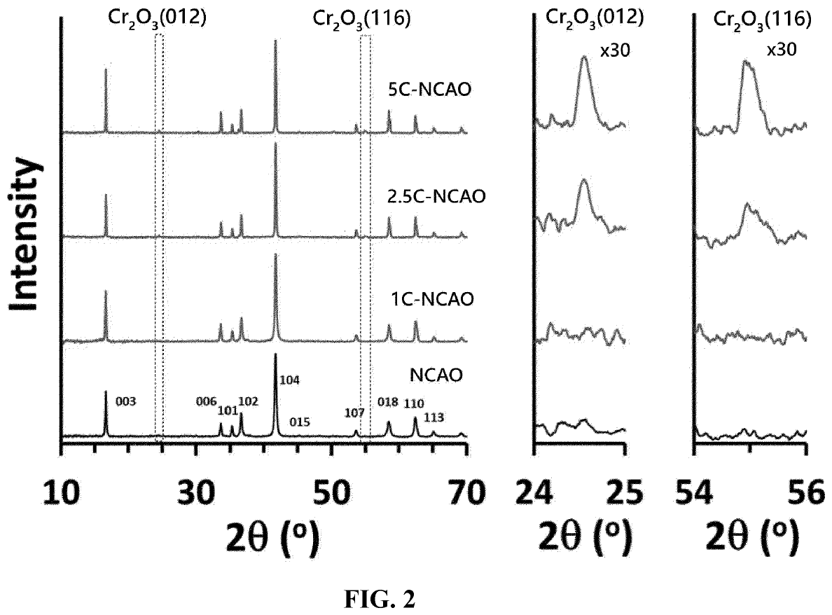

FIG. 2 is an XRD pattern of synthesized NCO and xC-NCAO (x=1, 2.5, 5). As determined in FIG. 2, XRD peaks of the synthesized xC-NCAO (x=1, 2.5, and 5) do not show deviation from XRD peaks of NCO. That is, the synthesized xC-NCAO (x=1, 2.5, and 5) has an O3 type structure. However, with the addition of Al, small new peaks begin to appear and become more prominent with an increase in the amount of Al. This new peaks correspond to the diffraction peaks of a-Cr₂O₃ ((012) and (116)), and this indicates that the mixture is phase separated into a Cr₂O₃-based phase and an NCO-based phase.

For the synthesized xC-NCAO (x=1, 2.5, and 5), Rietveld analysis was performed on the XRD pattern to determine whether the NCO structure was doped with Al.

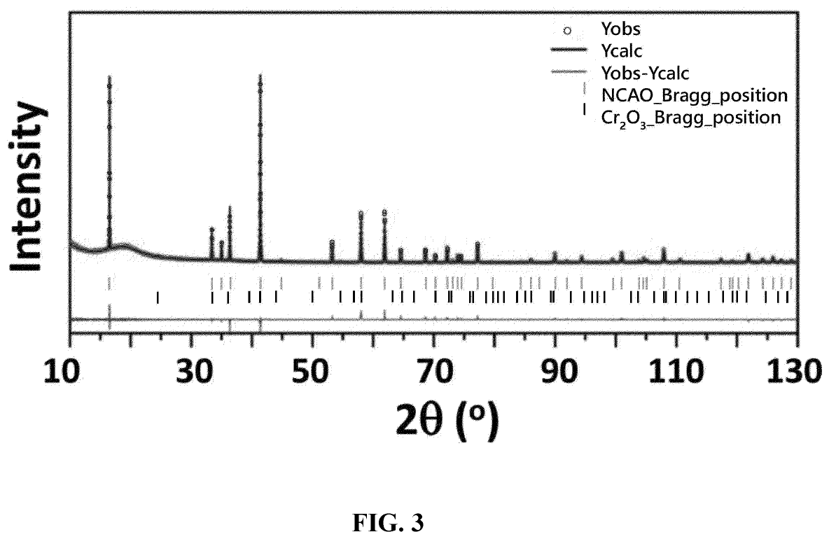

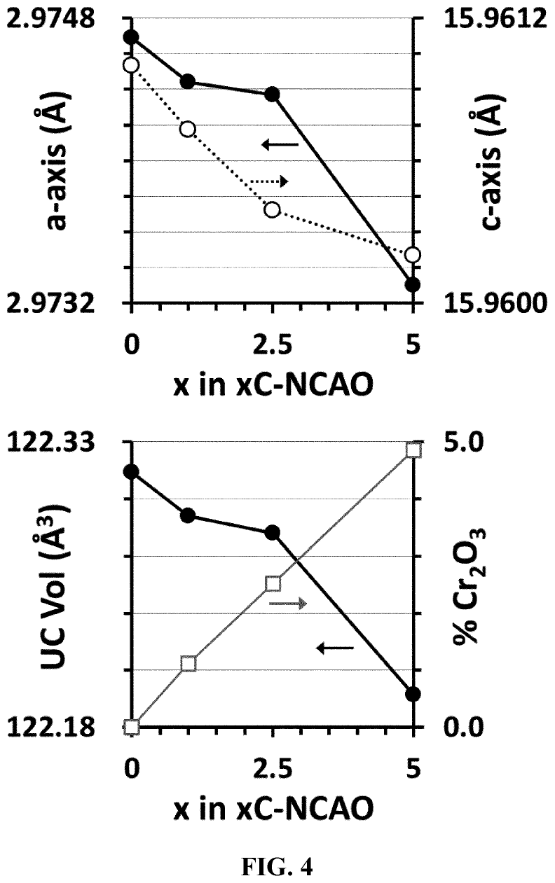

FIG. 3 is a fitting profile of 1C-NCAO, and FIG. 4 shows changes in lattice dimension according to x in xC-NCAO and mol % of Cr₂O₃ obtained through analysis. As determined in FIG. 4, the lattice parameters obtained through Rietveld analysis show a gradual contraction of unit cell dimensions (a continuous decrease in a and c axis lengths and unit cell volume) with the addition of Al. This behavior indicates that large-sized Cr³⁺(0.615 Å) is replaced by small-sized Al³⁺(0.535 Å) according to Vegard's law. In addition, a coated Cr₂O₃ fraction is approximately equal to half the mol % of added Al. That is, it was determined that two phases (xCr₂O₃ and Na(Cr₁₋₂ₓAl₂ₓ)O₂) were formed.

Thereafter, changes in surface composition according to the addition of Al was investigated using XPS to determine that the synthesized compound was composed of a Cr₂O₃ shell and an NCAO core instead of a mixture of Cr₂O₃ and NCAO.

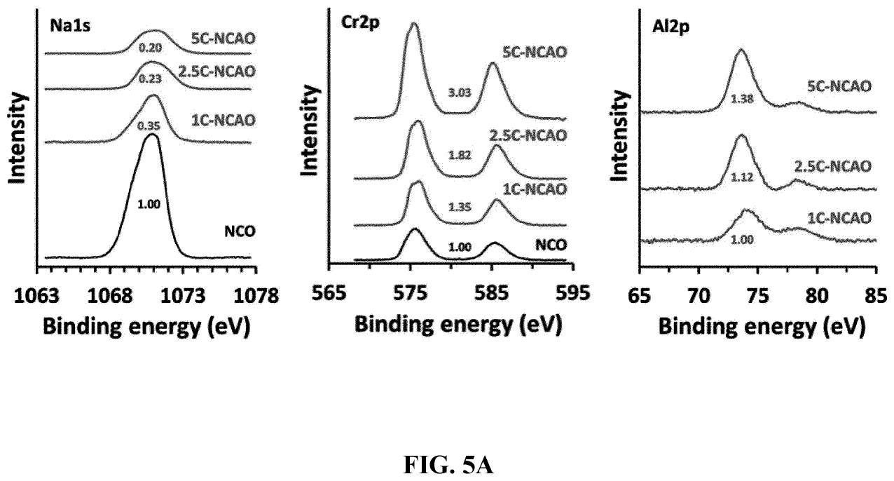

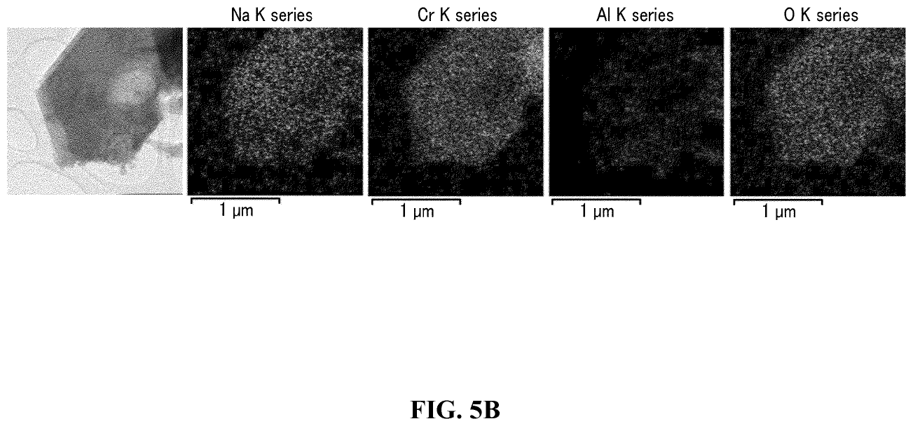

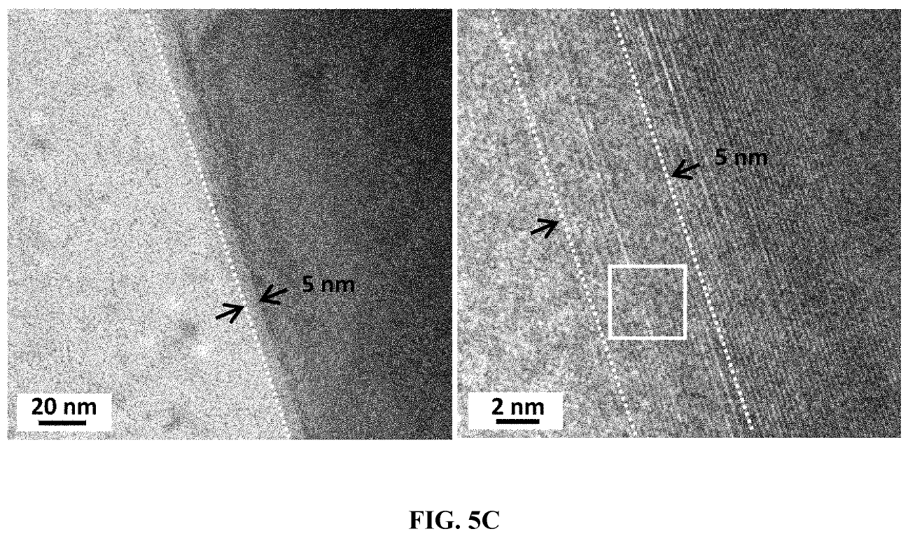

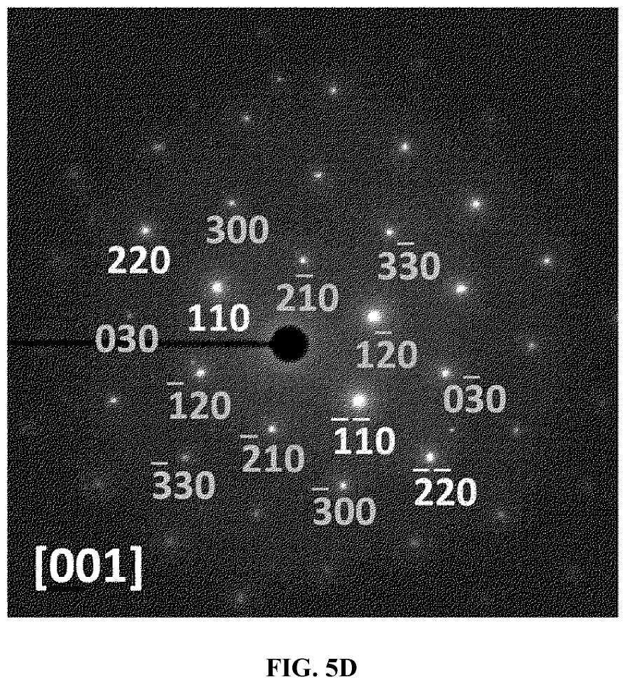

FIG. 5A is an XPS spectrum of Na, Cr, and Al for NCO and xC-NCAO, FIG. 5B is EDX mapping results related to an STEM image of 1C-NCAO, FIG. 5C is a high-resolution TEM image of 1C-NCAO, and FIG. 5D is an electron diffraction pattern of a portion indicated by a square in FIG. 5C.

Referring to FIGS. 5A to 5D, according to the addition of Al, the peak intensities of 1C-NCAO, 2.5C-NCAO, and 5C-NCAO were sharply reduced to 0.35, 0.23, and 0.20, respectively, compared to the Na₁ₛ peak intensity of NCO. In a case in which the synthesized material is simply composed of a mixture of Cr₂O₃ and NCAO, the Na₁ₛ peak intensity would gradually decrease with an increase in the amount of Al (e.g., 98%, 95%, and 90%), but the sharp decrease in the Na₁ₛ peak indicates that NCAO is present as a core. Meanwhile, Cr₂ₚ peak intensity showed an opposite behavior. Compared to the intensity of NCO, the Cr₂ₚ peak intensity sharply rose to 1.35, 1.82, and 3.03 in 1C-NCAO, 2.5C-NCAO, and 5C-NCAO, respectively. The element concentration of Cr hardly changes, and accordingly, the significant increase in Cr₂ₚ peak intensity indicates the Cr₂O₃ shell was formed on a surface of NCAO.

Reflecting the core-shell structure formed in the synthesized material, the Al₂ₚ peak also showed a nonlinear behavior with the addition of Al.

For example, the Al₂ₚ peak intensity in 2.5C-NCAO increased only 1.12 times the Al₂ₚ peak intensity in 1C-NCAO although the amount of Al increased by 2.5 times.

The relative atom % of constituent elements and the formation of the NCAO core and Cr₂O₃ shell were also determined through STEM. EDX mapping shows a uniform distribution of Na, Cr, Al, and O with the atom % of 24.5±0.3% for Na, 24.4±0.2% for Cr, 0.6±0.2% for Al, and 50.5±0.9% for O, which is almost identical to the relative atomic ratio of 1C-NCAO. High-resolution TEM imaging was performed on an edge of particles to determine the presence of the Cr₂O₃ shell. As a result of TEM imaging, a clear dark contrast in which an about 5 nm thick bright surface layer is clearly visible was observed, and the electron diffraction pattern of a peripheral region showed that the surface layer was composed of Cr₂O₃ (FIG. 5D).

That is, it was determined that particles composed of the Al-doped NaCrO₂ core and the Cr₂O₃ shell were synthesized through the above-described sol-gel method.

### Evaluation of Cycle Characteristics

A positive electrode for electrochemical testing was prepared as follows.

First, the synthesized active material (80 wt %), carbon black (10 wt %, Super P), and polyvinylidene fluoride (10 wt %, HSV900, MTI) were mixed with N-methyl-2-pyrrolidone to prepare a positive electrode slurry. The prepared positive electrode slurry was applied onto aluminum foil and vacuum dried for 6 hours to prepare a positive electrode. The prepared positive electrode was assembled into a coin cell (CR2032, Wellcos) with metallic sodium as a negative electrode. An electrolyte of the coin cell was a mixture of ethylene carbonate and dimethyl carbonate (EC:DMC=1:1) containing 1.0 M NaPF₆. All processes for the electrode preparation and the cell assembly were performed in an argon-filled glove box (O₂, H₂O<1 ppm).

Constant current charge/discharge cycle tests were performed using an automatic WBCS 3000 battery cycler (WonATech).

Electrochemical properties of xC-NCAO were tested during the constant current charge/discharge at a rate of 0.2 C (24 mA/g based on 1 C=120 mA/g) in a solution of 1.0 M NaPF₆ using Na metal as a counter electrode. In addition, for comparison with the xC-NCAO characteristics, the same charge/discharge cycle tests were performed on NCO, 0.025Cr₂O₃-coated NCO (no Al doping), and Al-doped NaCr_{0.95}Al_{0.05}O₂ (no Cr₂O₃ coating).

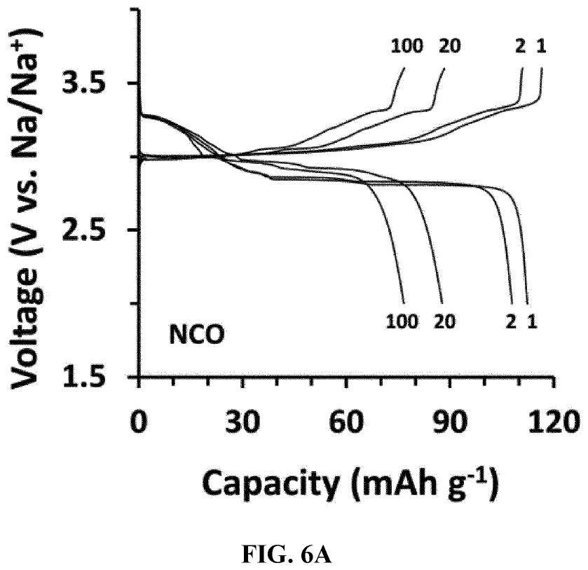

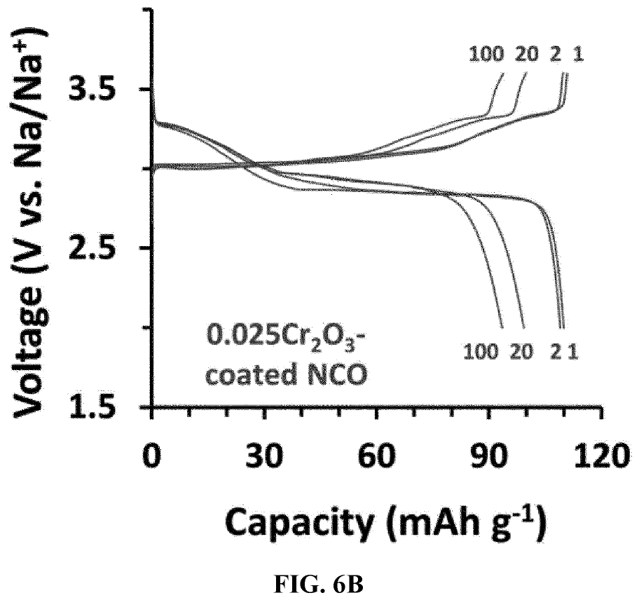

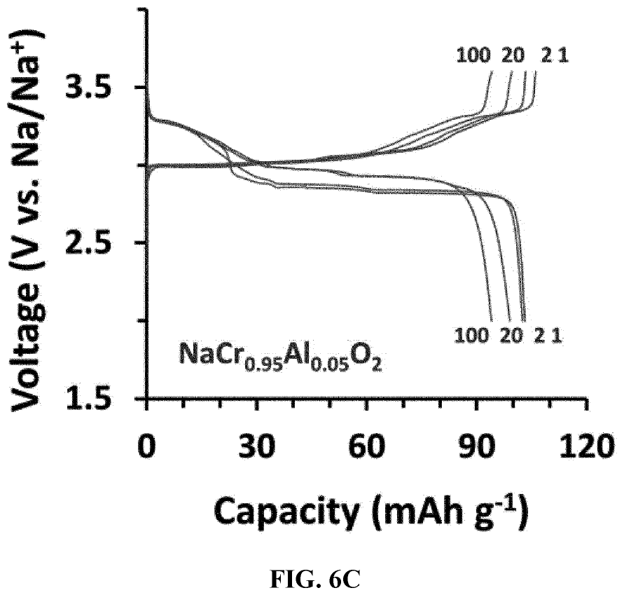

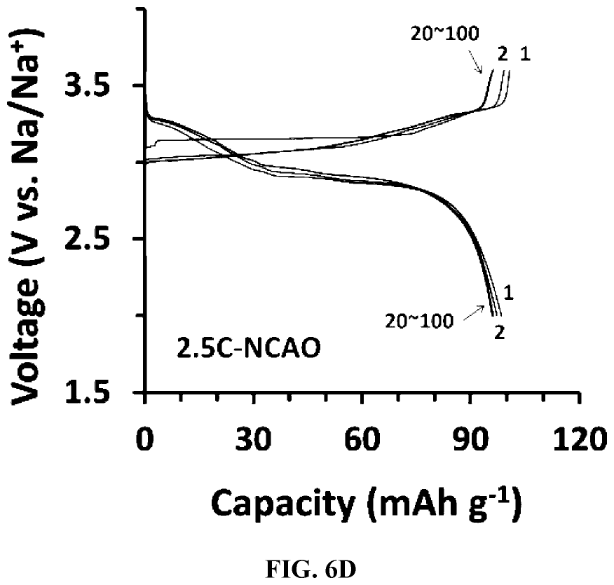

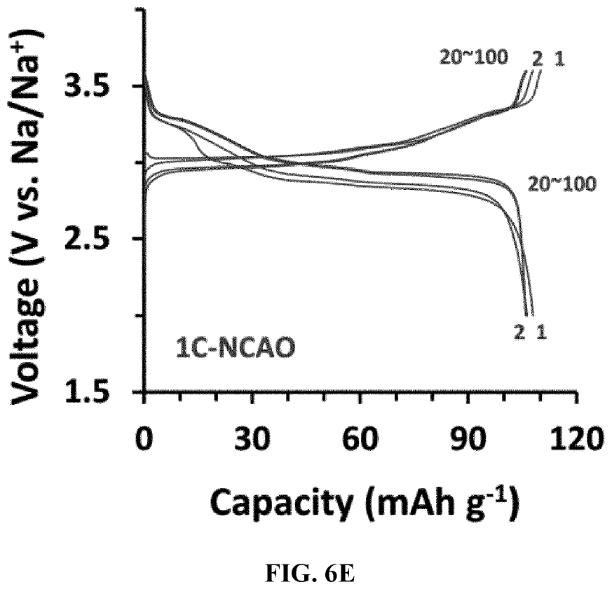

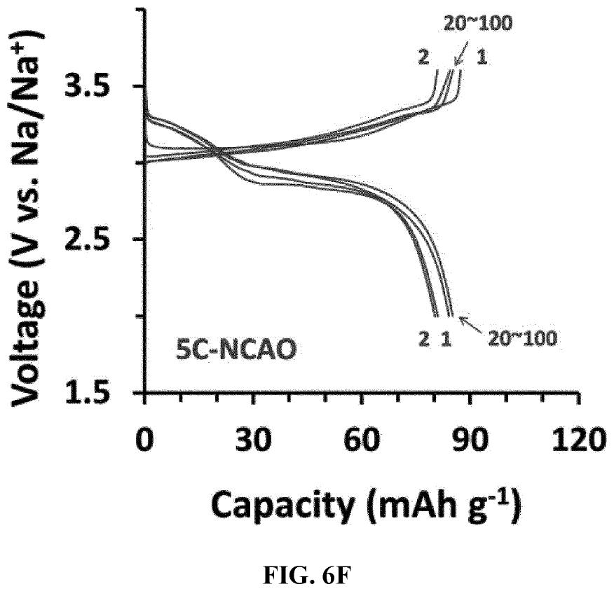

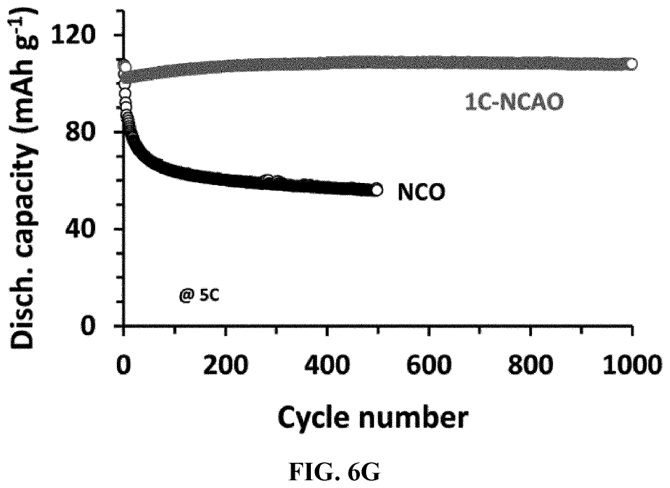

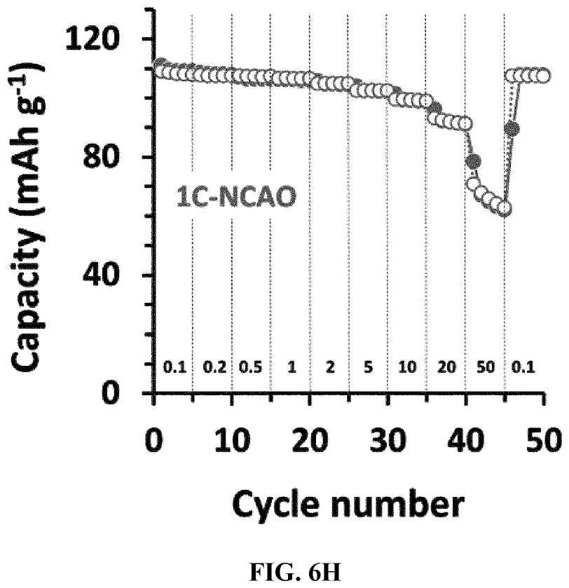

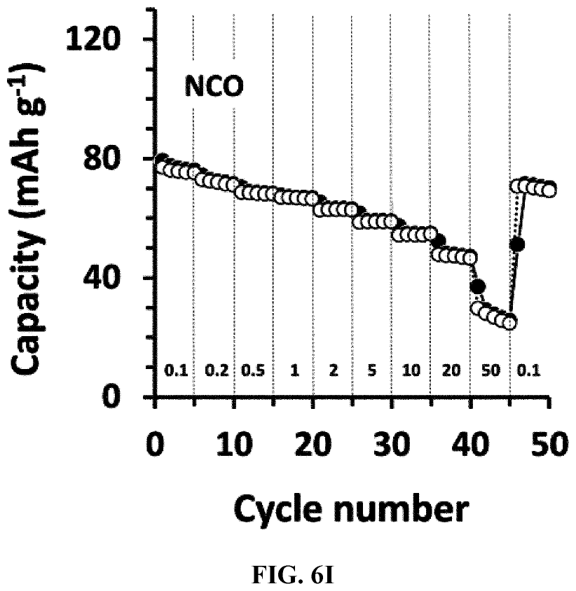

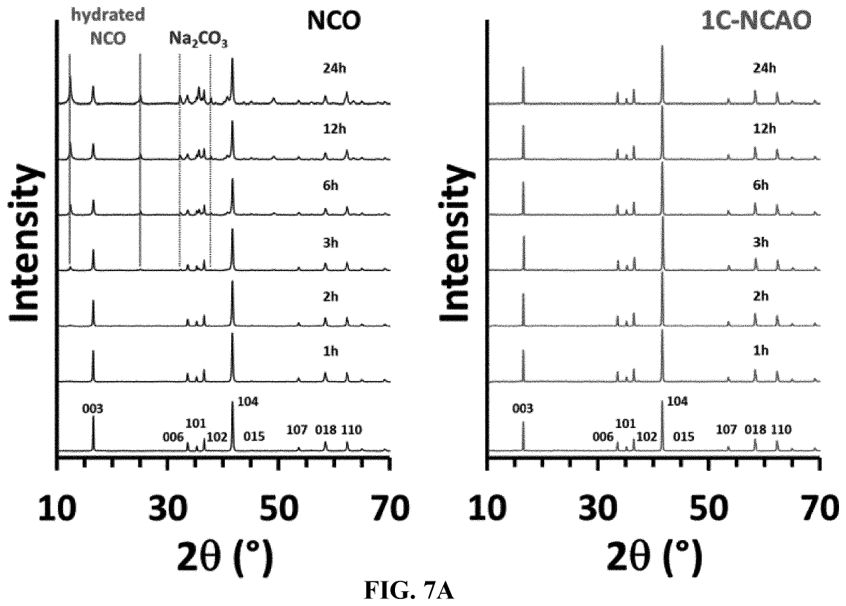

FIG. 6A shows changes in charge/discharge profile of NCO over 100 cycles. Although the high voltage cutoff was limited to 3.6 V (i.e., extraction of Na⁺ up to Na˜0.5CrO2), the cycle characteristics were insufficient due to continuous Cr dissolution and formation of an inert P′3 phase during repeated charge/discharge cycles. The primary discharge capacity of 112.3 mAh/g continued to decrease to 76.6 mAh/g after 100 charge/discharge cycles, and the fading rate was shown to be −0.36 mAhg⁻¹cycle⁻¹, a value similar to the previously reported value.

FIG. 6B shows changes in charge/discharge profile of 0.025Cr₂O₃-coated NCO (no Al doping) over 100 cycles. The first discharge capacity of 105.6 mAh/g decreased to 93.4 mAh/g after 100 charge/discharge cycles, showing a fading rate of −0.12 mAhg⁻¹cycle⁻¹. That is, it is seen that the discharge capacity retention characteristics of NCO were significantly improved through Cr₂O₃ coating.

FIG. 6C shows changes in charge/discharge profile of Al-doped NaCr_{0.95}Al_{0.05}O₂ (no Cr₂O₃ coating) over 100 cycles. The first discharge capacity was slightly reduced to 103.7 mAh/g, and the fading rate was improved to −0.10 mAhg⁻¹cycle⁻¹.

The fading rates of 0.025Cr₂O₃-coated NCO (no Al doping) and Al-doped NaCr_{0.95}Al_{0.05}O₂ (no Cr₂O₃ coating) are −0.12 mAhg⁻¹cycle⁻¹ and −0.10 mAhg⁻¹cycle⁻¹, respectively, indicating that further improvement is needed.

FIG. 6D shows changes in charge/discharge profile of 2.5C-NCAO over 100 cycles. There was an extremely small fading of the discharge capacity from 98.6 mAh/g to 96.2 mAh/g during the first two charge/discharge cycles, but it remained at 96 mAh/g during subsequent cycles, and coulombic efficiency was mostly 100% except for the first few cycles. That is, in the case of 2.5C-NCAO, the capacity was slightly reduced due to the inclusion of the electrically inert Cr₂O₃ shell and Al³⁺ dopant.

FIG. 6E shows changes in charge/discharge profile of 1C-NCAO over 100 cycles. A high discharge capacity of 107.9 mAh/g was provided during the first cycle, and although the discharge capacity slightly decreased to 106.3 mAh/g in the second cycle, no further fading was observed from the third cycle.

FIG. 6F shows changes in charge/discharge profile of 5C-NCAO over 100 cycles. This material has a thicker Cr₂O₃ layer and a larger amount of Al³⁺ dopant than 2.5C-NCAO, and thus has excellent cycle stability but a further reduction in reversible capacity.

Meanwhile, as determined in FIG. 6G, in the case of 1C-NCAO, the reversible capacity of 1C-NCAO was shown not to be degraded over 1000 charge/discharge cycles at 5 C. The discharge capacity initially decreased slightly (106.6→102.2 mAh/g), and then gradually increased over subsequent charge/discharge cycles. As a result, 1C-NCAO maintained a discharge capacity of 107 to 108 mAh/g during most charge/discharge cycles. In contrast, NCO, which showed a discharge capacity of 108.5 mAh/g during the first charge/discharge cycle, showed a significant decreased discharge capacity over the cycles, reaching a discharge capacity of 64 mAh/g and 56 mAh/g after 100 and 500 charge/discharge cycles, respectively.

In addition, 1C-NCAO has excellent rate characteristics, which is one of the favorable aspects of NCO. Despite the presence of a coating layer, the reversible capacity of 1C-NCAO did not significantly decrease from the high C-rate (FIG. 6H). A capacity of 99.2 mAh/g was shown at 10 C, and this corresponds to 91% at 0.1 C. When the C-rate is reversed to 0.1 C after cycling at 5 C, immediate recovery of capacity is shown. NCO for comparison also showed the same sequence of stepwise rate changes (FIG. 6I).

### Evaluation of Moisture Resistance

Positive electrode active materials for sodium ion batteries having a layered structure, such as NCO, are known to be sensitive to humid air, and water molecules may be inserted into an Na layer of the positive electrode active materials, causing expansion of the c-axis.

Powdered positive electrode active materials were exposed to air (humidity=about 3000 ppm) to evaluate moisture stability of the synthesized 1C-NCAO and NCO.

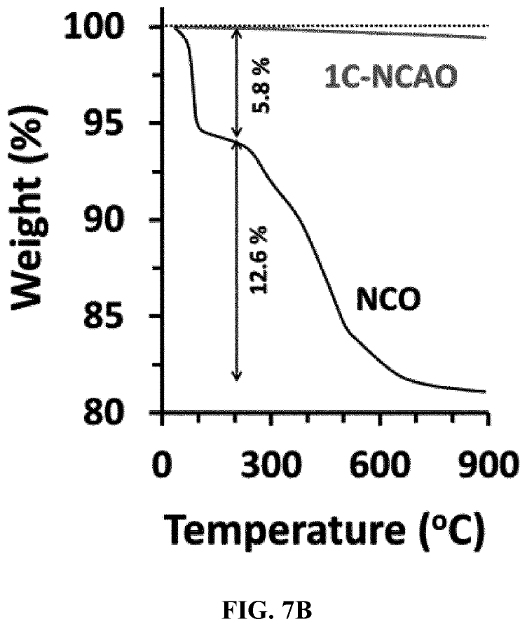

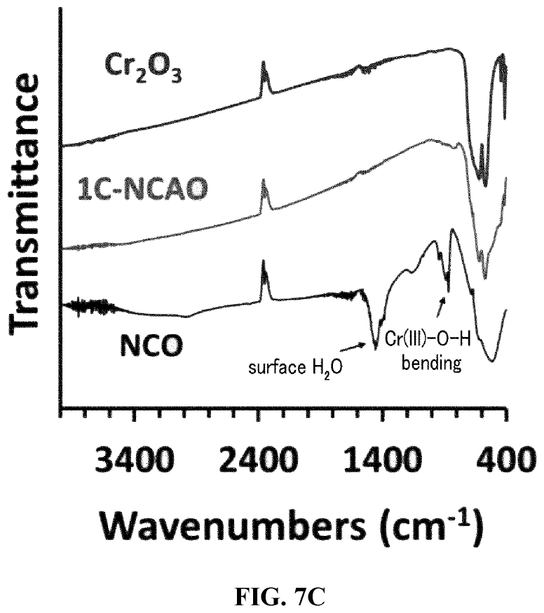

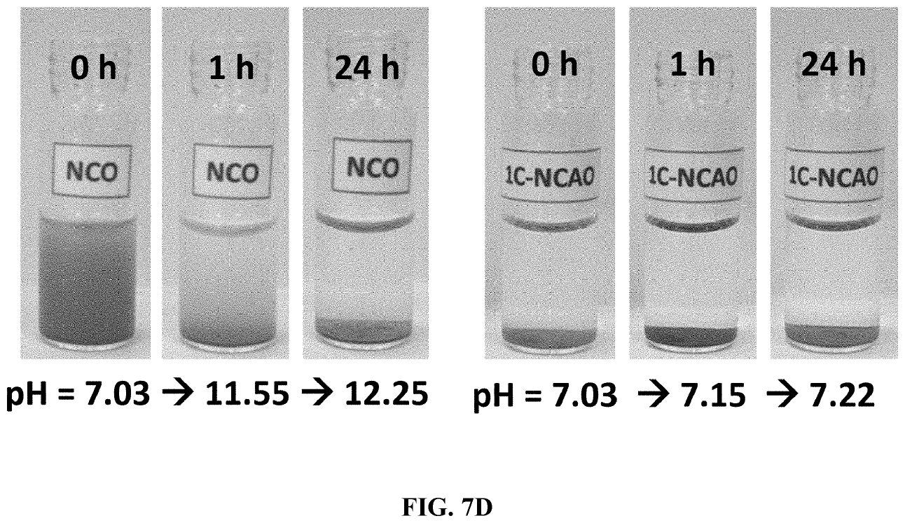

FIG. 7A shows the XRD pattern when NCO and 1C-NCAO were exposed to air for 24 hours. There is no change in the pattern for 1C-NCAO, but for NCO, new peaks begin to appear after 3 hours of exposure, and the peaks grow over time, and this corresponds to NCO with water inserted and Na₂CO₃, a surface by-product.

NCO and 1C-NCAO were exposed to air for 24 hours and then heated to 900° C. As determined in FIG. 7B, 1C-NCAO had a minimal weight loss of 99.4% during the heating, which was consistent with the results of XRD, and NCO had a significant and continuous weight loss of 5.8 to 12.6% at 100 to 600° C., and this is attributed to surface water release (−5.8%) and dehydration of water molecules inserted into the Na layer (−12.6%).

In FIG. 7C, the FTIR spectrum also showed the stability of 1C-NCAO in humid air. NCO showed characteristic peaks of surface adsorbed water (1460 cm⁻¹) and Cr(III)—OH bonds (866 cm⁻¹), whereas no indication of the presence of water was observed in 1C-NCAO.

NCO and 1C-NCAO powder were added to water as shown in FIG. 7D to determine whether resistance of the Cr₂O₃ shell present in 1C-NCAO against water also works in an aqueous solution. NCO powder appears to have an affinity for water, but gradual precipitation takes place and water is adsorbed and dissolved on a surface of NCO, leaving a yellow-green liquid. In addition, a significant increase in pH over time was observed in the solution containing NCO, with a pH increasing from 7.03 to 11.55 after 1 hour and to 12.25 after 24 hours. This increase is attributed to Na⁺/H⁺ exchange (NaMO₂+xH₂O→Na₁₋ₓHₓMO₂+xNaOH) that takes place in most 03-type Na layered materials. In contrast, no signs of interaction or reaction with water (no color change) were observed in the solution containing 1C-NCAO, and the pH change was relatively small (from 7.03 to 7.15 and to 7.22). Accordingly, it is seen that the thin Cr₂O₃ shell formed in 1C-NCAO provides inert properties in water as well as moisture in the air.

A positive electrode active material according to the invention exhibits excellent cycle stability and durability against water when applied to a positive electrode of a sodium ion battery.

According to a method for preparing a positive electrode active material according to the invention, a positive electrode active material having a core-shell structure, in which a shell is formed on a surface thereof to increase cycle stability and improve durability against humidity, may be prepared through a simple one-pot process.

What is claimed is:

1. A positive electrode active material for a sodium ion battery, comprising:
core particles having a composition of Formula 1 below; and
a shell composed of chromium oxide formed on a surface of the core particles,
Na(Cr₁₋₂ₓAl₂ₓ)O₂ (x is 0.001 to 0.1) [Formula 1].

2. The positive electrode active material for a sodium ion battery according to claim 1, wherein the chromium oxide is Cr₂O₃.

3. The positive electrode active material for a sodium ion battery according to claim 1, wherein the chromium oxide is applied at a molar ratio of xCr₂O₃ (x is 0.001 to 0.1).

4. The positive electrode active material for a sodium ion battery according to claim 1, wherein the shell has a thickness of 1 to 30 nm.

5. The positive electrode active material for a sodium ion battery according to claim 1, wherein the positive electrode active material is inert to water or moisture in the air.

6. A sodium ion battery comprising:
a positive electrode;
a negative electrode disposed at a predetermined distance from the positive electrode;
a separator disposed between the positive electrode and the negative electrode; and
an electrolyte charged between the positive electrode and the negative electrode, and the separator,
wherein the positive electrode comprises the positive electrode active material according to claim 1.

7. A method for preparing a positive electrode active material for a sodium ion battery, comprising:
dissolving a sodium (Na) precursor, a chromium (Cr) precursor, and an aluminum (Al) precursor in a solvent to prepare a solution;
adding a chelating agent to the solution and stirring the mixture;
drying the solution to obtain a compound containing sodium, chromium, and aluminum;
heating the compound at a temperature of 400 to 600° C. to remove carbon contained in the compound; and
sintering the compound from which the carbon is removed at a temperature of 700 to 1,000° C. to obtain a positive electrode active material including core particles having a composition of Formula 1 below and a shell composed of chromium oxide formed on a surface of the core particles,
Na(Cr₁₋₂ₓAl₂ₓ)O₂ (x is 0.001 to 0.03) [Formula 1].

8. The method according to claim 7, wherein the chelating agent is citric acid.

9. The method according to claim 7, wherein the solvent is water.
